(19) United States
(12) Patent Application Publication
(10) Pub. No.: US 2014/0129507 A1
(43) Pub. Date: May 8, 2014

(54) INFORMATION PROCESSING DEVICE, INFORMATION PROCESSING METHOD AND PROGRAM

(71) Applicant: SONY CORPORATION, Tokyo (JP)

(72) Inventors: YOSHIKI TANAKA, Kanagawa (JP); YUICHI KAGEYAMA, Tokyo (JP); MITSURU TAKEHARA, Tokyo (JP); HISAHIRO SUGANUMA, Tokyo (JP)

(73) Assignee: SONY CORPORATION, Tokyo (JP)

(21) Appl. No.: 14/031,258

(22) Filed: Sep. 19, 2013

(30) Foreign Application Priority Data
Nov. 8, 2012 (JP) 2012-245979

(51) Int. Cl. G06N 7/02

(52) U.S. Cl. CPC G06N 7/02
USPC 706/52

(57) ABSTRACT

There is provided an information processing device, including a predictive calculating unit that alternately recalculates a pair of matrices derived from an input matrix including an unknown element with reference to the input matrix, and generates a pair of feature matrices used to calculate an output matrix including a prediction value of the unknown element.

### CROSS REFERENCE TO RELATED APPLICATIONS

This application claims the benefit of Japanese Priority Patent Application JP 2012-245979 filed Nov. 8, 2012, the entire contents of which are incorporated herein by reference.

### BACKGROUND

The present disclosure relates to an information processing device, an information processing method, and a program.

It is a general technique to express and process a variety of information as a matrix. A matrix is composed of elements specified by rows and columns but includes an unknown element depending on circumstances. In this case, various techniques of predicting an unknown element using a known element included in a matrix and using a prediction value have been proposed.

For example, in Yunhong Zhou, Dennis Wilkinson, Robert Schreiber and Rong Pan's “Large-scale Parallel Collaborative Filtering for the Netflix Prize,” Proc. 4th Int'l Conf. Algorithmic Aspects in Information and Management, LNCS 5034, 2008, a technique of receiving an evaluation matrix having an evaluation value of an item by a user as an element and calculating a predictive evaluation matrix including a prediction value of an unknown element included therein is disclosed. The predictive evaluation matrix is calculated by multiplying a user feature matrix calculated from an evaluation matrix by an item feature matrix.

In the technique disclosed in Yunhong Zhou, Dennis Wilkinson, Robert Schreiber and Rong Pan's “Large-scale Parallel Collaborative Filtering for the Netflix Prize,” Proc. 4th Int'l Conf. Algorithmic Aspects in Information and Management, LNCS 5034, 2008, the user feature matrix and the item feature matrix are derived from the evaluation matrix a using singular value decomposition or the like, and then the user feature matrix and the item feature matrix are repeatedly updated in an alternate manner such that an error between a matrix obtained by multiplying the matrices and the evaluation matrix is reduced This technique is called alternating least squares (ALS).

A prediction value of an unknown element in the evaluation matrix which is represented by the predictive evaluation matrix is an evaluation value considered to be allocated to an item which is not used by the user yet when the item is newly used. A degree of the user's interest in the new item is predicted based on the evaluation value, and an item in which the user is predicted to have a high degree of interest is recommended to the user. Such item filtering is also known as collaborative filtering.

### SUMMARY

However, in recent years, due to the advancement in communication technology, the diversification of services provide via a network, and the like, users or items serving as targets of collaborative filtering have become numerous, and thus an evaluation matrix has increased in size. Further, cases in which, as the user newly evaluates an item, an element of an evaluation matrix is frequently updated have increased.

Meanwhile, in the technique disclosed in Yunhong Zhou, Dennis Wilkinson, Robert Schreiber and Rong Pan's “Large-scale Parallel Collaborative Filtering for the Netflix Prize,” Proc. 4th Int'l Conf. Algorithmic Aspects in Information and Management, LNCS 5034, 2008, a highly accurate prediction result can be calculated, but as a matrix increases in size, a time taken for a calculation increases, and it is difficult to rapidly cope with an update of an element of a matrix. Thus, the user is not sufficiently satisfied in terms of a real-time property.

It is desirable to propose an information processing device, an information processing method, and a program, which are novel and improved, and capable of rapidly coping with an update of an element of an input matrix when an output matrix including a prediction value of an unknown element included in the input matrix is calculated.

According to an embodiment of the present disclosure, there is provided an information processing device, including a predictive calculating unit that alternately recalculates a pair of matrices derived from an input matrix including an unknown element with reference to the input matrix, and generates a pair of feature matrices used to calculate an output matrix including a prediction value of the unknown element. The input matrix includes a first input matrix and a second input matrix configured such that some elements of the first input matrix are updated. The output matrix includes a first output matrix calculated corresponding to the first input matrix and a second output matrix calculated corresponding to the second input matrix. The predictive calculating unit causes a number of the recalculations when the pair of feature matrices are generated from the second input matrix to be smaller than a number of the recalculations when the pair of feature matrices are generated from the first input matrix, by using the pair of feature matrices generated from the first input matrix instead of the pair of matrices derived from the second input matrix.

According to an embodiment of the present disclosure, there is provided an information processing method, including generating a pair of feature matrices by acquiring a first input matrix including an unknown element and alternately recalculating a pair of matrices derived from the first input matrix with reference to the first input matrix, and calculating a first output matrix including a prediction value of the unknown element based on the pair of feature matrices, and generating a new pair of feature matrices by acquiring a second input matrix configured such that some elements of the first input matrix are updated and alternately recalculating the pair of feature matrices generated from the first input matrix with reference to the second input matrix, and calculating a second output matrix including a prediction value of the unknown element based on the pair of feature matrices. A number of the recalculations when the second output matrix is calculated is smaller than a number of the recalculations when the first output matrix is calculated.

According to an embodiment of the present disclosure, there is provided a program that causes a computer to implement a function of alternately recalculating a pair of matrices derived from an input matrix including an unknown element with reference to the input matrix, and generating a pair of feature matrices used to calculate an output matrix including a prediction value of the unknown element. The input matrix includes a first input matrix and a second input matrix configured such that some elements of the first input matrix are updated. The output matrix includes a first output matrix calculated corresponding to the first input matrix and a second output matrix calculated corresponding to the second input matrix. The function causes a number of the recalculations when the pair of feature matrices are generated from the second input matrix to be smaller than a number of the recalculations when the pair of feature matrices are generated from the first input matrix, by using the pair of feature matrices generated from the first input matrix instead of the pair of matrices derived from the second input matrix.

According to one or more of embodiments of the present disclosure, it is possible to rapidly cope with an update of an element of an input matrix when an output matrix including a prediction value of an unknown element included in the input matrix is calculated.

### BRIEF DESCRIPTION OF THE DRAWINGS

FIG. 1 is a diagram for describing an outline of a first embodiment of the present disclosure;

FIG. 2 is a diagram for describing an outline of the first embodiment of the present disclosure;

FIG. 3 is a block diagram illustrating a schematic functional configuration of a server according to the first embodiment of the present disclosure;

FIG. 4 is a diagram illustrating an exemplary evaluation matrix generated in the first embodiment of the present disclosure;

FIG. 5 is a diagram for describing an exemplary matrix calculation in the first embodiment of the present disclosure;

FIG. 6 is a diagram for describing an exemplary repetitive recalculation of a matrix in the first embodiment of the present disclosure;

FIG. 7 is a diagram for describing exemplary reuse of a feature matrix in the first embodiment of the present disclosure;

FIG. 8 is a diagram for describing an additional exemplary configuration of a matrix calculation in the first embodiment of the present disclosure;

FIG. 9 is a block diagram illustrating a schematic functional configuration of a server according to a second embodiment of the present disclosure;

FIG. 10 is a diagram for describing an error calculation in the second embodiment of the present disclosure;

FIG. 11 is a diagram for describing an error calculation in the second embodiment of the present disclosure; and

FIG. 12 is a block diagram for describing a hardware configuration of an information processing device.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will proceed in the following order.

1. First embodiment
1-1. Outline
1-2. Functional configuration
1-3. Exemplary matrix calculation
1-4. Additional exemplary matrix calculation

2. Second embodiment
2-1. Functional configuration
2-2. Exemplary error calculation

3. Hardware configuration

4. Supplement

### 1. First Embodiment

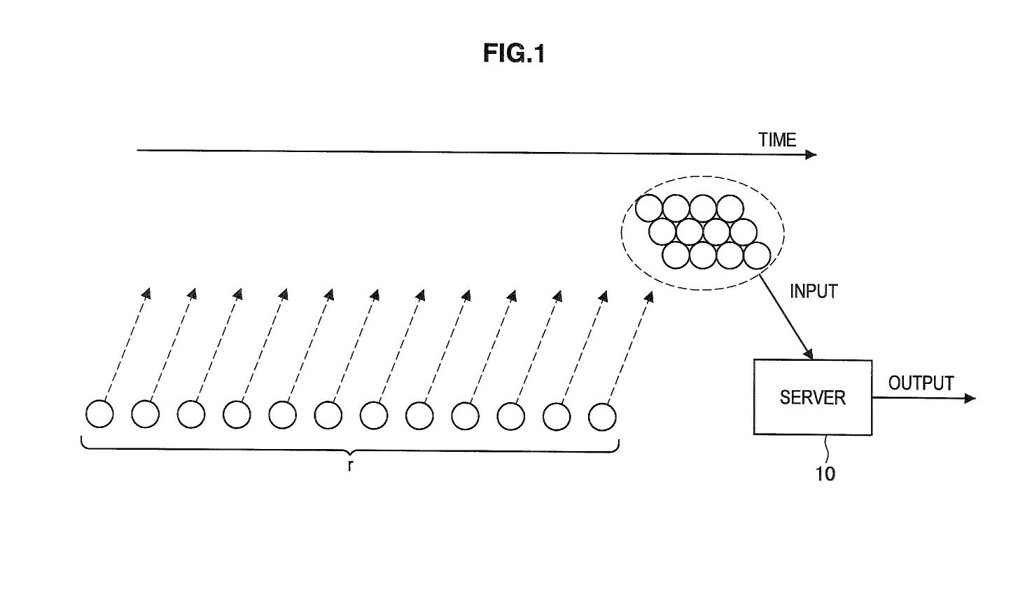

First of all, a first embodiment of the present disclosure will be described with reference to FIGS. 1 to 8. The present embodiment relates to a server that calculates a predictive evaluation matrix including a prediction value of an unknown element in an evaluation matrix through a matrix calculation using an evaluation matrix having an evaluation value of an item by the user received as an input as an element, and outputs item recommendation information to the user using the prediction value The server may be implemented by a single information processing device or may be implemented by a combination of a plurality of information processing devices connected via a wired or wireless network. An exemplary hardware configuration for implementing each information processing device will be described later.

(1-1. Outline)

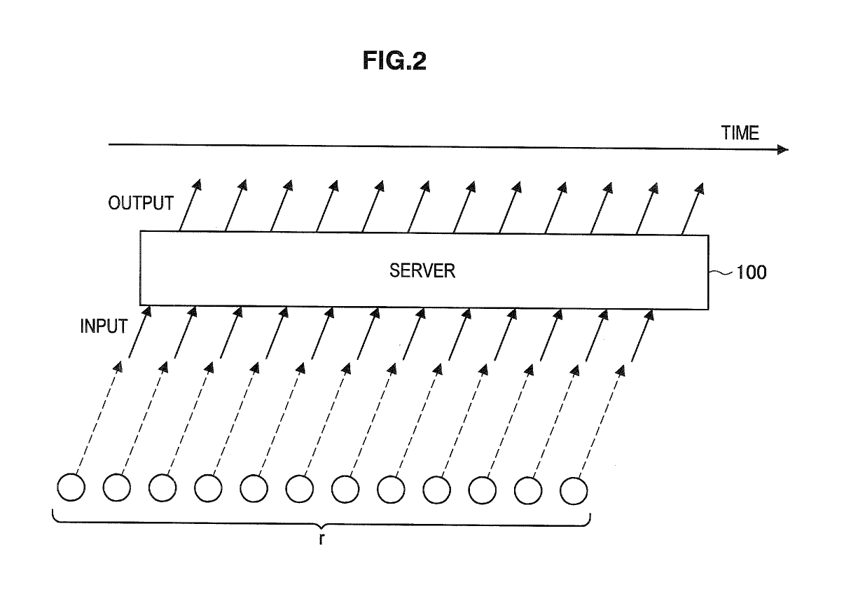

FIGS. 1 and 2 are diagrams for describing an outline of the first embodiment of the present disclosure. FIG. 1 is a reference diagram illustrating a processing form (batch processing) different from that of the present embodiment, and FIG. 2 is a diagram illustrating a processing form (real time processing) according to the present embodiment.

In the batch processing illustrated in FIG. 1, evaluation data r which is data representing an evaluation value of an item from the user is accumulated during a predetermined period of time. A server 10 generates an evaluation matrix R based on the accumulated evaluation data r, and calculates a predictive evaluation matrix R′ through a matrix calculation such as ALS. When the size of a matrix to be dealt with is large, it takes time to calculate the user feature matrix and the item feature matrix, and an update of the matrices is repeated in the process of calculation, and thus it takes time until the predictive evaluation matrix R′ is calculated.

In the case of the above batch processing, for example, it takes time until the process of calculating the predictive evaluation matrix R′ in which the evaluation data r is reflected starts after the evaluation data r is provided by the user. Further, although the process starts, it take a little more time until the predictive evaluation matrix R′ is calculated. Thus, it is difficult to rapidly feed an item recommendation result in which the evaluation data r is reflected back to the user who has provided the evaluation data r. Meanwhile, it is often desirable for the user who has provided the evaluation data r to get feedback on the provided data rapidly.

In this regard, in the present embodiment, real time processing illustrated in FIG. 2 is implemented. In the real time processing, evaluation data r which is data representing evaluation values of items by the user is sequentially input to a server 100 as streaming data. The server 100 updates an existing evaluation matrix R based on the sequentially input evaluation data r, and calculates a predictive evaluation matrix R′ based on the updated evaluation matrix R. Thus, the server 100 sequentially outputs item recommendation information using the predictive evaluation matrix R′ in response to input of new evaluation data r.

In order to implement such real time processing, in the present embodiment, when the evaluation matrix R is updated after the predictive evaluation matrix R′ is calculated once, a predictive evaluation matrix R′ corresponding to the updated evaluation matrix R is calculated using a past calculation result during a short period of time. To this end, a more specific configuration will be described below.

(1-2. Functional Configuration)

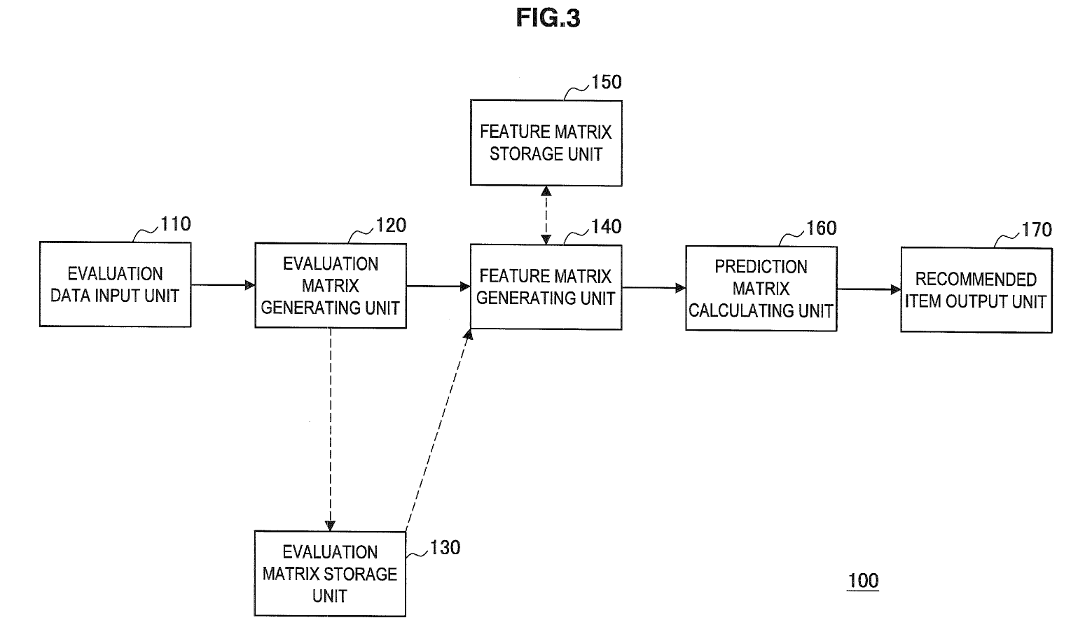

FIG. 3 is a block diagram illustrating a schematic functional configuration of a server according to the first embodiment of the present disclosure. As described above, the server 100 may be implemented by a single information processing device or a combination of a plurality of information processing devices. In the latter case, a functional configuration of the server 100 which will be described below may be implemented by a single information processing device or may be implemented such that a single functional component may be dispersed among a plurality of information processing devices.

The server 100 includes an evaluation data input unit 110, an evaluation matrix generating unit 120, an evaluation matrix storage unit 130, a feature matrix generating unit 140, a feature matrix storage unit 150, a prediction matrix calculating unit 160, and a recommended item output unit 170 as functional components. The functional components will be described below.

The evaluation data input unit 110 is an interface that receives input of the evaluation data r. The evaluation data r is temporally dispersed and sequentially input. For example, the evaluation data input unit 110 is a wired or wireless communication device, and receives the evaluation data r transmitted from another device. Alternatively, the evaluation data input unit 110 may be an input device which is used for the user to input the evaluation data r and installed in a terminal device. Further, the evaluation data input unit 110 may also include a portion implemented as a central processing unit (CPU) of an information processing device operates according to a program. In this case, the evaluation data input unit 110 may have a function of activating processing of the evaluation matrix generating unit 120 and subsequent processing, for example, when input of the evaluation data r is received.

The evaluation matrix generating unit 120 generates the evaluation matrix R based on the evaluation data r. As described above, the evaluation matrix R is a matrix including evaluation values of items by the user as elements. Further, the evaluation matrix generating unit 120 stores the generated evaluation matrix R in the evaluation matrix storage unit 130, and updates the evaluation matrix R stored in the evaluation matrix storage unit 130 based on the evaluation data r when the evaluation data input unit 110 receives input of new evaluation data r. For example, the evaluation matrix generating unit 120 is implemented by the CPU of the information processing device operating according to a program.

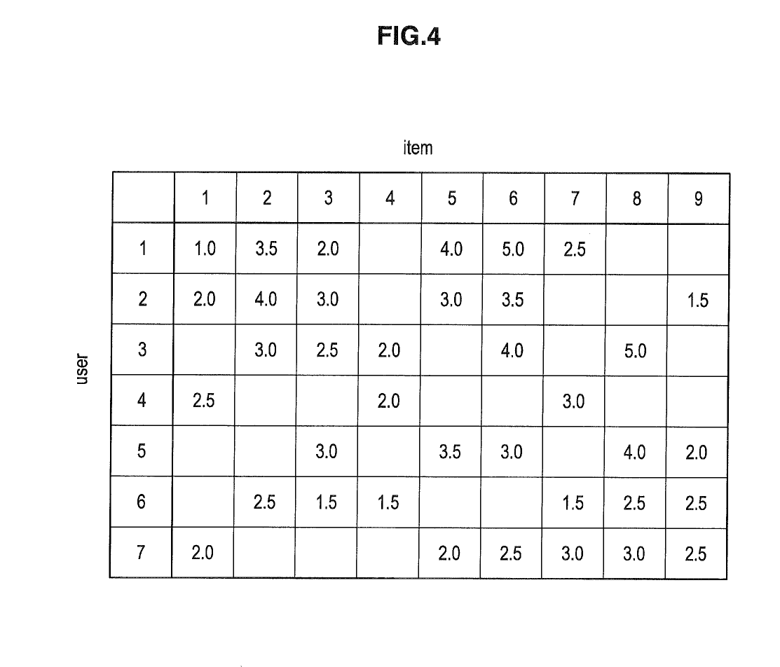

Here, an exemplary evaluation matrix generated by the evaluation matrix generating unit 120 is illustrated in FIG. 4. FIG. 4 is a diagram illustrating an exemplary evaluation matrix generated in the first embodiment of the present disclosure. In the evaluation matrix R illustrated in FIG. 4, users 1 to 9 are defined as a row, items 1 to 9 are defined as a column, and evaluation values of the items are used as elements of the matrix. In the evaluation matrix R, for example, an evaluation value of the item 1 by the user 1 is 1.0, and an evaluation value of the item 4 by the user 3 is 2.0. In practice, the evaluation matrix R may include more rows and columns than in the illustrated example.

The evaluation matrix R includes an unknown element. For example, an evaluation value of the item 4 by the user 1 is blank, and an evaluation value of the item 1 by the user 3 is blank. This represents that the user has not evaluated an item yet. In the server 100, the feature matrix generating unit 140 and the prediction matrix calculating unit 160 which will be described later predict unknown elements of the evaluation matrix R, that is, non-input evaluation values using the other known evaluation values (evaluation values of other items by the same user and evaluation values of the same items by different users), and the recommended item output unit 170 outputs information used to recommend an item to the user based on the predicted evaluation values.

The evaluation matrix storage unit 130 stores the evaluation matrix R generated by the evaluation matrix generating unit 120. For example, in the case of the batch processing, since the evaluation matrix R is newly generated in each processing, the evaluation matrix R is often discarded without being stored. However, in the present embodiment, since the real time processing is performed as the evaluation matrix R is sequentially updated, the evaluation matrix R generated once is stored in the evaluation matrix storage unit 130, and when input of new evaluation data r is received by the evaluation data input unit 110, the evaluation matrix R is updated based on the evaluation data r. For example, the evaluation matrix storage unit 130 is implemented by a storage device of the information processing device.

The feature matrix generating unit 140 derives a user feature matrix Fu and an item feature matrix Fi which are a pair of feature matrices used to calculate the predictive evaluation matrix R′ through a matrix calculation using the evaluation matrix R. Here, when a previously derived feature matrix is stored in the feature matrix storage unit 150, the feature matrix generating unit 140 simplifies a matrix calculation by deriving a new feature matrix with reference to the feature matrix. The details of this point will be described later. For example, the feature matrix generating unit 140 is also implemented by the CPU of the information processing device operating according to a program.

The feature matrix storage unit 150 stores a feature matrix derived by the feature matrix generating unit 140. In the present embodiment, the feature matrices are the user feature matrix Fu and the item feature matrix Fi. For example, in the case of the batch processing, since the feature matrix is newly generated in each processing, the feature matrix is often not stored. However, in the present embodiment, since the feature matrix is calculated in real time as the evaluation matrix R is sequentially updated, a feature matrix derived once is stored in the feature matrix storage unit 150, and then used when the feature matrix generating unit 140 drives a new feature matrix. For example, the feature matrix storage unit 150 is implemented by the storage device of the information processing device.

The prediction matrix calculating unit 160 multiplies the user feature matrix Fu and the item feature matrix Fi obtained in the feature matrix generating unit 140, and calculates the predictive evaluation matrix R′. As described above, the predictive evaluation matrix R′ is a matrix including a prediction value of an unknown element (evaluation value) included in the evaluation matrix R. The prediction matrix calculating unit 160 provides the calculated predictive evaluation matrix R′ or information of a predictive evaluation value included in the predictive evaluation matrix R′ to the recommended item output unit 170. For example, the prediction matrix calculating unit 160 is also implemented by the CPU of the information processing device operating according to a program.

The recommended item output unit 170 is an interface that outputs an item recommendation result based on the predictive evaluation matrix R′ in real time, for example, in response to input of the evaluation data r. For example, the recommended item output unit 170 is a wired or wireless communication device, and transmits an item recommendation to a client terminal device, for example. Alternatively, the recommended item output unit 170 may be an output device which is installed in a terminal device and provides an item recommendation result to the user. Further, the recommended item output unit 170 may include a portion implemented as the CPU of the information processing device operates according to a program. In this case, for example, the recommended item output unit 170 may have a function of editing information (for example, a web page) to be provided to the user using the item recommendation result.

(1-3. Exemplary Matrix Calculation)

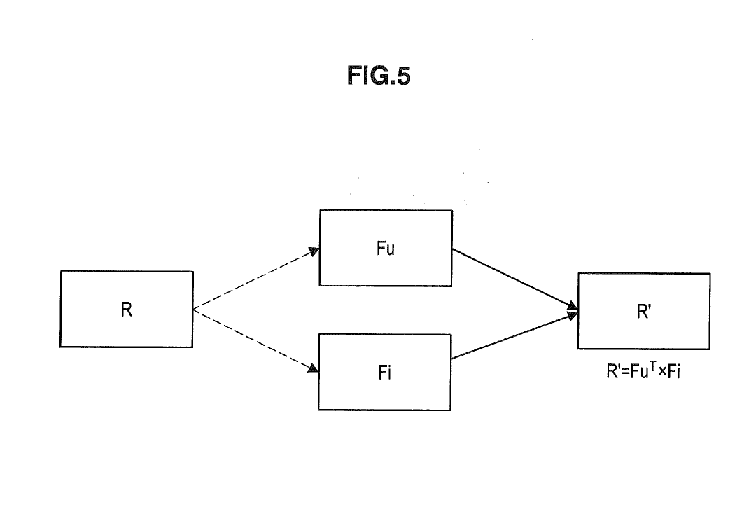

Here, an exemplary matrix calculation performed by the feature matrix generating unit 140 is illustrated in FIG. 5. FIG. 5 is a diagram for describing an exemplary matrix calculation in the first embodiment of the present disclosure. As illustrated in FIG. 5, the feature matrix generating unit 140 calculates the predictive evaluation matrix R′ including a prediction value of an unknown element in the evaluation matrix R by deriving a pair of feature matrices Fu and Fi from the evaluation matrix R and multiplying the matrices (R′=Fu^{T}×Fi).

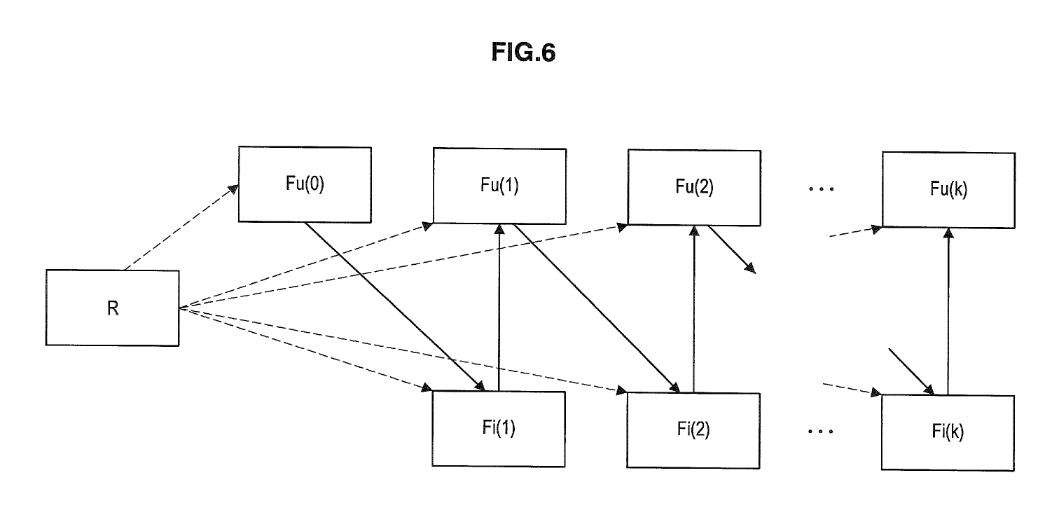

In the above-described matrix calculation, the feature matrices Fu and Fi are derived from the evaluation matrix R using singular value decomposition (SVD), for example. However, when the predictive evaluation matrix R′ is initially calculated from the evaluation matrix R, it is not easy to obtain appropriate matrices as the feature matrices Fu and Fi. In this regard, for example, the feature matrices Fu and Fi are calculated through a repetitive recalculation illustrated in FIG. 6. FIG. 6 is a diagram for describing an exemplary repetitive recalculation of a matrix in the first embodiment of the present disclosure. In FIG. 6, numbers such as (0) and (1) represent the number of recalculations at that point in time.

In the example illustrated in FIG. 6, first, a user feature matrix Fu(0) is derived from the evaluation matrix R by singular value decomposition or the like. Next, an item feature matrix Fi(1) is derived based on the user feature matrix Fu(0) and the evaluation matrix R. Specifically, the user feature matrix Fu(0) is fixed, and the item feature matrix Fi(1) is decided so that an error between the predictive evaluation matrix R′ calculated as in Fu(0)^{T}×Fi(1)=R′ and the evaluation matrix R is minimum. Next, the item feature matrix Fi(1) is fixed, and the user feature matrix Fu(1) is decided so that an error between the predictive evaluation matrix R′ calculated as in Fu(1)^{T}×Fi(1)=R′ and the evaluation matrix R is minimum. Thereafter, in a similar way, a recalculation of the feature matrices Fu and Fi is repeated a predetermined number of times (k times), and then the prediction matrix calculating unit 160 calculates the predictive evaluation matrix R′ by Fu(k)^{T}×Fi(k)=R′.

Meanwhile, since the evaluation matrix R tends to increase in size as described above, a processing amount of the above-described repetitive recalculation also increases. Thus, it is difficult to implement the real time processing illustrated in FIG. 2 in the technique of obtaining the feature matrices Fu and Fi through the above-described repetitive recalculation process each time the evaluation matrix R is updated by input of the evaluation data r. In this regard, in the present embodiment, the feature matrix generating unit 140 employs a configuration which will be described below and controls a processing amount for deriving the feature matrices Fu and Fi.

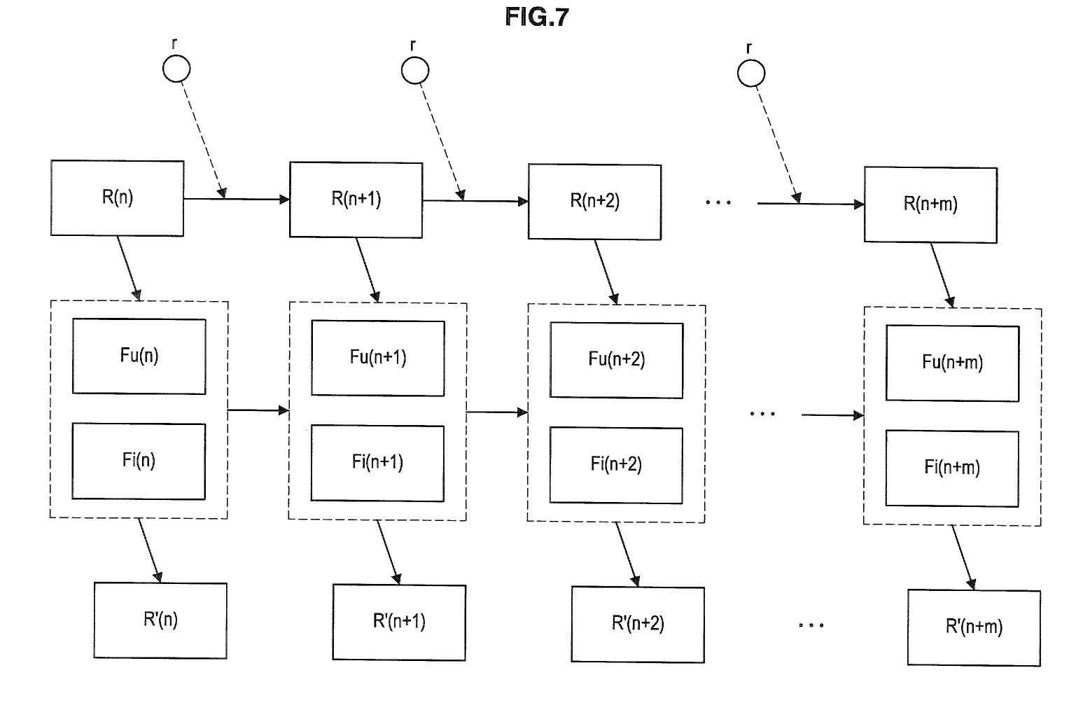

FIG. 7 is a diagram for describing exemplary reuse of a feature matrix in the first embodiment of the present disclosure. In the example illustrated in FIG. 7, in an (n-th) matrix calculation process at a certain point in time, feature matrices Fu(n) and Fi(n) are derived from the evaluation matrix R(n), and the prediction matrix calculating unit 160 calculates the predictive evaluation matrix R′(n) by Fu(n)^{T}×Fi(n)=R′(n).

In an (n+1)-th matrix calculation process performed when the evaluation matrix R(n) is updated to the evaluation matrix R(n+1) according to input of the evaluation data r, feature matrices Fu(n+1) and Fi(n+1) are derived from an evaluation matrix (n+1), and the prediction matrix calculating unit 160 calculates the predictive evaluation matrix R′ (n+1) by Fu(n+1)^{T}×Fi(n+1)=R′ (n+1).

Here, the feature matrices Fu(n+1) and Fi(n+1) derived in the (n+1)-th matrix calculation process are obtained by a recalculation based on the feature matrices Fu(n) and Fi(n) derived in the n-th matrix calculation process. For example, in the (n+1)-th process, the item feature matrix Fi(n+1) is decided using the immediately previous user feature matrix Fu(n) as a temporary user feature matrix Fu so that an error between the predictive evaluation matrix R′ calculated as in Fu(n)^{T}×Fi(n+1)=R′ and the evaluation matrix R(n+1) can be minimized. At this time, the item feature matrix Fi(n+1) may be searched based on the immediately previous item feature matrix Fi(n). Next, the item feature matrix Fi(n+1) is fixed, and the user feature matrix Fu(n+1) is decided so that an error between the predictive evaluation matrix R′ calculated as in Fu(n+1)^{T}×Fi(n+1)=R′ and the evaluation matrix R(n+1) can be minimized.

In the example illustrated in FIG. 7, when the feature matrices Fu(n+1) and Fi(n+1) are obtained by the recalculation based on the feature matrices Fu(n) and Fi(n) derived in the immediately previous process, the number of recalculations of the feature matrices Fu(n+1) and Fi(n+1) may be smaller than the number (k) of repetitions of the example illustrated in FIG. 6, and may be, for example, one. In other words, in the example illustrated in FIG. 7, the feature matrix generating unit 140 can derive the feature matrices Fu(n+1) and Fi(n+1) by the above-described process, that is, a single recalculation, and calculate the predictive evaluation matrix R′(n+1) as in Fu(n+1)^{T}×Fi(n+1)=R′(n+1).

This example is possible because the evaluation matrix R(n+1) is derived by updating only a limited element (for example, a single element) in the evaluation matrix R(n) according to the evaluation data r. In other words, the evaluation matrix R(n+1) is the same as the evaluation matrix R(n) on elements other than elements in a user row related to the evaluation data r and elements in an item column related to the evaluation data r. Thus, the feature matrices Fu(n) and Fi(n) appropriate to calculate a predictive evaluation matrix R′(n) are likely to approximate the feature matrices Fu(n+1) and Fi(n+1) appropriate to calculate the evaluation matrix R′(n+1). Accordingly, when the recalculation is performed based on the feature matrices Fu(n) and Fi(n) instead of a matrix derived from the evaluation matrix R(n+1) using the SVD or the like, the appropriate feature matrices Fu(n+1) and Fi(n+1) can be derived from a small number of recalculations.

In the example illustrated in FIG. 7, in the (n+2)-th to (n+m)-th matrix calculation processes, similarly, the user feature matrices Fu and Fi are obtained by the recalculation based on the feature matrix derived in the immediately previous matrix calculation process, and the prediction matrix calculating unit 160 calculates the predictive evaluation matrix R′ from the user feature matrices Fu and Fi. Through this configuration, when the evaluation matrix R is updated with the evaluation data r, the feature matrix generating unit 140 can reduce the number of recalculations when the feature matrices Fu and Fi are derived and control the processing amount.

(1-4. Additional Exemplary Matrix Calculation)

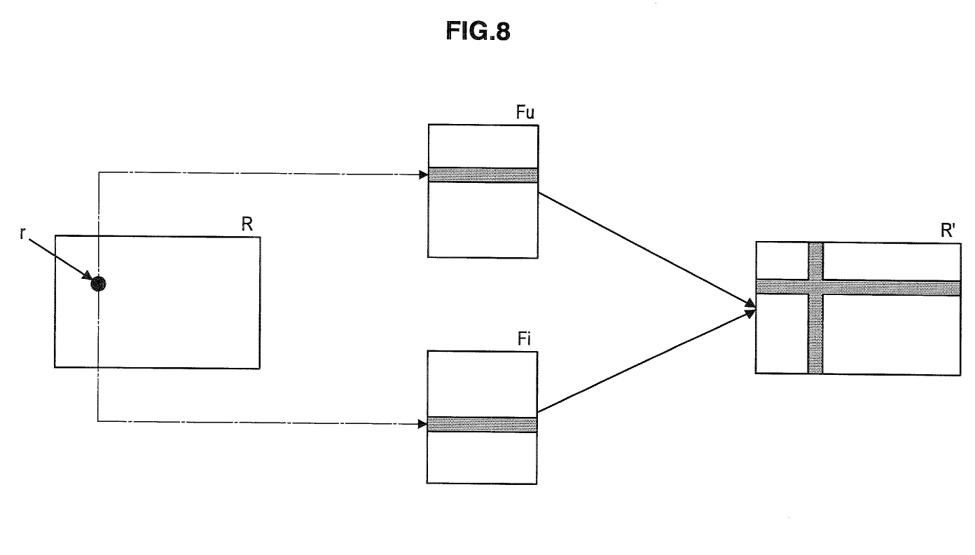

FIG. 8 is a diagram for describing an additional exemplary configuration of a matrix calculation in the first embodiment of the present disclosure. In the example illustrated in FIG. 8, the feature matrices Fu and Fi are derived from the updated evaluation matrix R, and when the predictive evaluation matrix R′ is calculated as in Fu^{T}×Fi=R′, a row serving as a recalculation target is limited to some rows of the feature matrices Fu and Fi.

Here, as described above, the evaluation matrix R is updated with the evaluation data r. Since the evaluation data r is data of an evaluation value of an item by a certain user, the updated evaluation matrix R is the same as the non-updated evaluation matrix R on elements other than elements in a user row related to the evaluation data r and elements in an item column related to the evaluation data r. Thus, in the recalculation of the feature matrices Fu and Fi with the update of the evaluation matrix R, elements other than elements in rows corresponding to the row and the column are likely to be the same or to approximate the non-updated feature matrices Fu and Fi. Thus, in the example illustrated in FIG. 8, the processing amount can be further suppressed by limiting a row serving as a recalculation target when the feature matrices Fu and Fi are derived and using the immediately previous feature matrices Fu and Fi without change for the remaining rows.

In the above example, a row serving as a recalculation target may not necessarily be a row corresponding to a user and an item related to an update. Since rows other than rows of a user and an item related to an update are practically affected by an update of the evaluation matrix R, it is desirable to add several rows as well as the rows as a recalculation target in terms of improvement in the accuracy of the predictive evaluation matrix R′. For example, one or more rows which are randomly selected may be added as a recalculation target in addition to the rows corresponding to a user and an item related to an update. Further, for example, one or more rows corresponding to a user and an item which are high in relevance with a user or an item related to an update may be added as a recalculation target based on relevance information of a user or an item which is prepared in advance.

In the above-described first embodiment of the present disclosure, in a matrix calculation using an evaluation matrix having an element as an evaluation value of an item by the user, the processing amount for deriving the feature matrix caused to calculate the predictive evaluation matrix can be significantly reduced. Thus, for example, item recommendation by collaborative filtering using the predictive evaluation matrix can be implemented in real time while following evaluation data that sequentially changes.

### 2. Second Embodiment

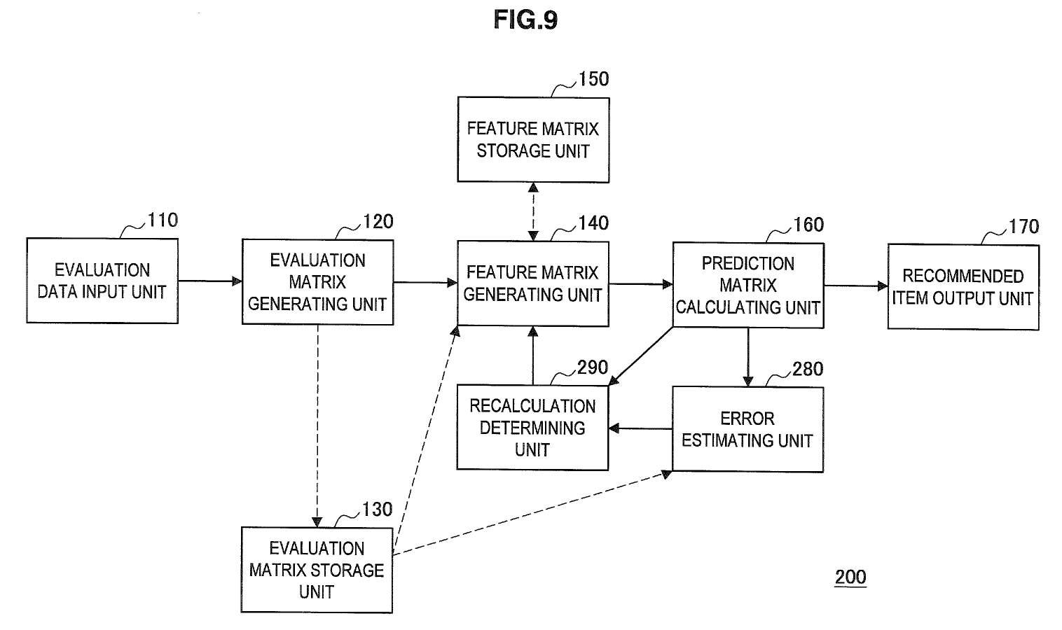

Next, a second embodiment of the present disclosure will be described with reference to FIGS. 9 to 11. The present embodiment relates to a server that calculates a predictive evaluation matrix including a prediction value of an unknown element in an evaluation matrix through a matrix calculation using an evaluation matrix having an evaluation value of an item by the user received as an input as an element, and outputs item recommendation information to the user using the prediction value, similarly to the first embodiment. However, the present embodiment is different from the first embodiment in that an error estimating unit that estimates an error of a predictive evaluation matrix and a recalculation determining unit that determines the necessity of a recalculation of a feature matrix based on the estimated error are provided. Thus, the following description will proceed focusing on the different points, and a repeated description on the same configuration as in the first embodiment will be omitted.

(2-1. Functional Configuration)

FIG. 9 is a block diagram illustrating a schematic functional configuration of a server according to a second embodiment of the present disclosure. A server 200 may be implemented by a single information processing device or may be implemented by a combination of a plurality of processing devices, similarly to the server 100 according to the first embodiment. In the latter case, a functional configuration of the server 200 which will be described later may be implemented by a single information processing device or may be implemented such that a single functional component may be dispersed among a plurality of information processing devices.

The server 200 includes an evaluation data input unit 110, an evaluation matrix generating unit 120, an evaluation matrix storage unit 130, a feature matrix generating unit 140, a feature matrix storage unit 150, a prediction matrix calculating unit 160, a recommended item output unit 170, an error estimating unit 280, and a recalculation determining unit 290 as functional components. The error estimating unit 280 and the recalculation determining unit 290 which are functional components different from those the first embodiment will be described below.

The error estimating unit 280 estimates an error of the predictive evaluation matrix R′ calculated in the prediction matrix calculating unit 160. For example, the error estimating unit 280 estimates an error by calculating a root mean square error (RMSE) between the predictive evaluation matrix R′ and the original evaluation matrix R stored in the evaluation matrix storage unit 130. At this time, the error estimating unit 280 uses a simplified calculation method as will described below rather than a typical RMSE calculation method. For example, the error estimating unit 280 is implemented by the CPU of the information processing device operating according to a program.

When the error of the predictive evaluation matrix R′ estimated by the error estimating unit 280 exceeds a predetermined range, the recalculation determining unit 290 does not use a past feature matrix stored in the feature matrix storage unit 150, and requests the feature matrix generating unit 140 to recalculate the feature matrices Fu and Fi from the evaluation matrix R at that point in time through a repetitive recalculation of a predetermined number of times (k times) such as one illustrated in FIG. 6. In this case, the prediction matrix calculating unit 160 recalculates the predictive evaluation matrix R′ based on the recalculated feature matrices Fu and Fi. For example, the recalculation determining unit 290 is also implemented by the CPU of the information processing device operating according to a program.

(2-2. Exemplary Error Calculation)

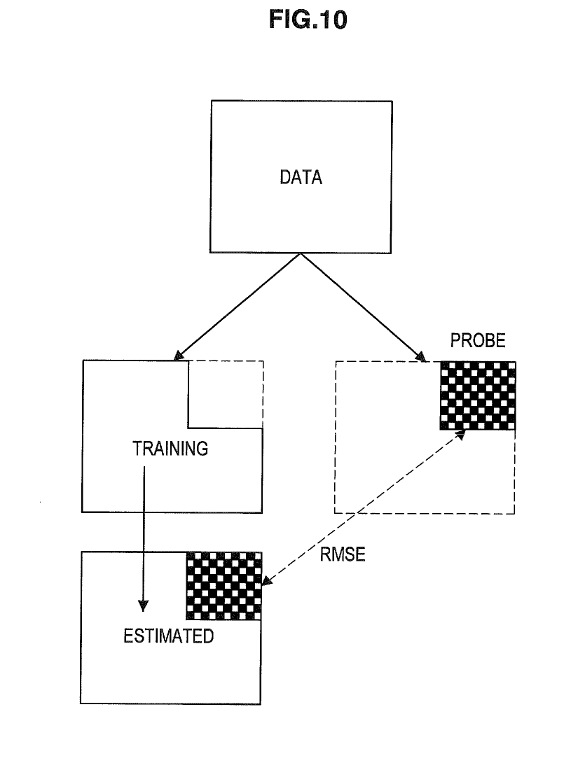

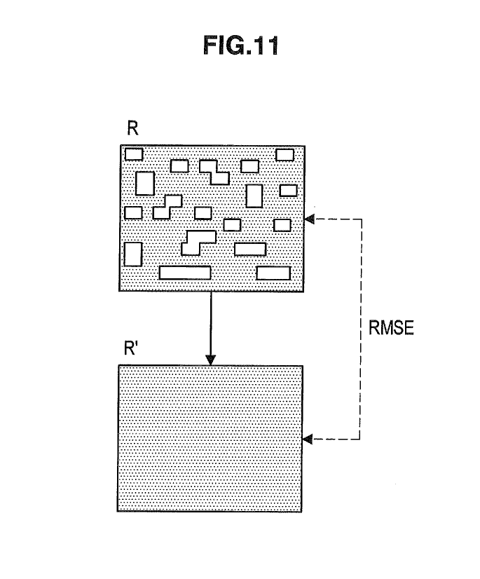

Here, an exemplary calculation of an error of the predictive evaluation matrix R′ in the error estimating unit 280 will be described with reference to FIGS. 10 and 11. FIG. 10 is a diagram illustrating a general RMSE calculation method different from that of the present embodiment, and FIG. 11 illustrates an RMSE calculation method in the present embodiment.

In the general calculation method, as illustrated in FIG. 10, a data matrix (DATA) is divided into a training portion (TRAINING) and a probe portion (PROBE), and a matrix calculation is performed using the training portion as an input matrix. A prediction matrix (ESTIMATED) obtained as a result of the matrix calculation includes a prediction value of the probe portion which was blank (an unknown element) in the input matrix. Element prediction accuracy by the matrix calculation can be evaluated by calculating the RMSE between the prediction value and the actual value of the probe portion.

Meanwhile, in the calculation method according to the present embodiment, as illustrated in FIG. 11, a matrix calculation is performed using the evaluation matrix R as the input matrix to calculate the predictive evaluation matrix R′, and the RMSE between a known element included in the evaluation matrix R and an element of the predictive evaluation matrix R′ corresponding to the corresponding element is calculated. When the predictive evaluation matrix R′ is calculated, a value is calculated by the calculation on a known element as well as an unknown element included in the evaluation matrix R, and thus the element prediction accuracy by the matrix calculation can be evaluated based on an error between the calculated value and an original element value of the evaluation matrix R.

Of the two calculation methods, a mathematically rigorous error calculation can be performed by the general calculation method. On the other hand, an error calculated by the calculation method according to the present embodiment is not as rigorous as the general calculation method. However, in the calculation method according to the present embodiment, since it is unnecessary to divide data into two portions, a calculation of a prediction value and a calculation of an error can be included in a single matrix calculation.

In a calculation of the feature matrices Fu and Fi using a past feature matrix stored in the feature matrix storage unit 150 in the feature matrix generating unit 140, the processing amount can be suppressed by efficiently omitting a calculation, but some errors occur when a calculation is omitted. When the errors are accumulated, the accuracy of the prediction value in the predictive evaluation matrix R′ is likely to be lowered. Thus, in the present embodiment, the error estimating unit 280 calculates an error of the predictive evaluation matrix R′, and when the error exceeds a predetermined range, the recalculation determining unit 290 requests the feature matrix generating unit 140 to recalculate the feature matrices Fu and Fi from the evaluation matrix R through a repetitive operation.

However, as new users or items are added, the evaluation matrix R increases in size. Further, since the evaluation data r is sequentially input, a matrix calculation by the feature matrix generating unit 140 can also be performed with a high frequency. Thus, it is not easy to perform a matrix calculation for error evaluation separately from the original matrix calculation as in the general calculation method. Meanwhile, in the calculation method according to the present embodiment, since an error can be evaluated using the original matrix calculation result, it is easy to perform error evaluation through the error estimating unit 280 in parallel with the matrix calculation by the feature matrix generating unit 140.

As described above, the error calculated by the calculation method according to the present embodiment does not compare to the general calculation method in terms of mathematical rigor. However, in the error estimating unit 280, it is unnecessary to calculate an accurate error by an absolute reference, and it is consequential to detect a relative change tendency such as whether or not errors are increasing. Thus, in the present embodiment, the error estimating unit 280 calculates an error of the matrix calculation through the above-described calculation method, and the recalculation determining unit 290 determines whether or not the feature matrices Fu and Fi are to be recalculated based on the error, and thus the feature matrices Fu and Fi can be recalculated at an appropriate timing, and the element prediction accuracy can be maintained.

Further, as a modified example of the present embodiment, the recalculation determining unit 290 may determine whether or not the feature matrices Fu and Fi are to be recalculated using a reference other than an error calculated by the error estimating unit 280. For example, the recalculation determining unit 290 may determine that the feature matrices Fu and Fi are to be recalculated when a calculation of the predictive evaluation matrix R′ reusing a past feature matrix stored in the feature matrix storage unit 150 has been performed a predetermined number of times or more. Further, the recalculation determining unit 290 may determine that the feature matrices Fu and Fi are to be recalculated when a predetermined number of new users or new items or more are added to the evaluation matrix R. Alternatively, the recalculation determining unit 290 may determine that the feature matrices Fu and Fi are to be recalculated every predetermined time period. In this case, the error estimating unit 280 may not necessarily be installed.

In the above-described second embodiment of the present disclosure, similarly to the first embodiment, the processing amount for deriving the feature matrix caused to calculate the predictive evaluation matrix can be significantly reduced, and the predictive evaluation matrix is recalculated through the original repetitive recalculation under a predetermined condition. Thus, for example, item recommendation by collaborative filtering using the predictive evaluation matrix can be implemented in real time while following evaluation data that sequentially changes, and the accuracy of the prediction result can be prevented from being lowered due to accumulation of errors.

### 3. Hardware Configuration

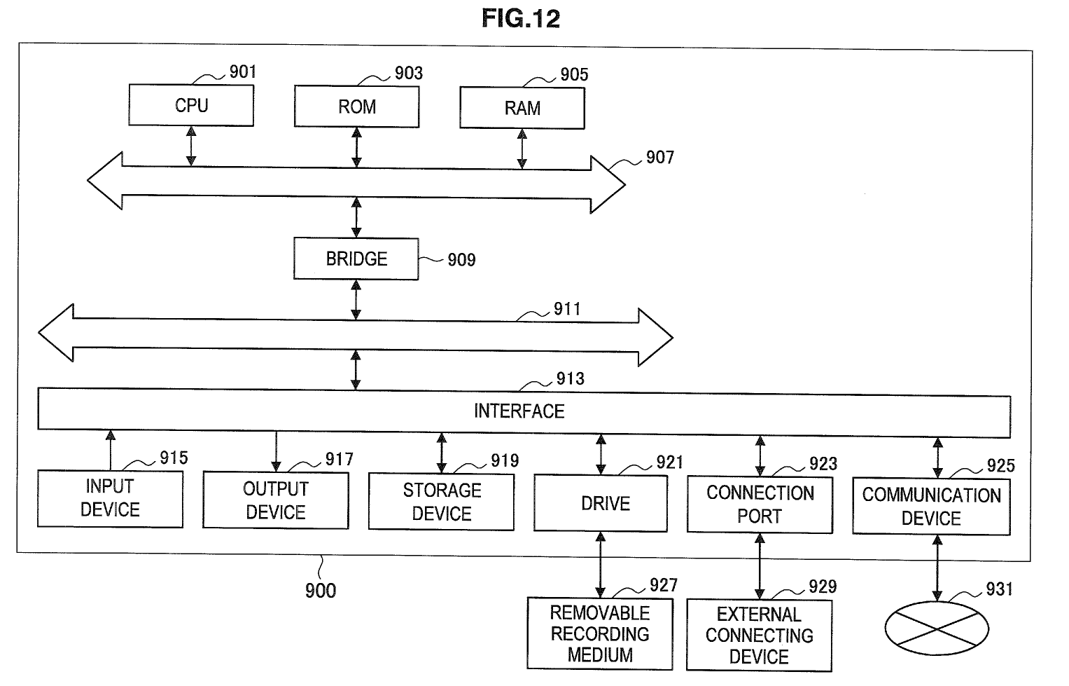

Next, a hardware configuration of an information processing device according to an embodiment of the present disclosure will be described with reference to FIG. 12. FIG. 12 is a block diagram for describing a hardware configuration of an information processing device. For example, an information processing device 900 illustrated in FIG. 12 may be implemented by one or more information processing devices that configure the server according to the above embodiments.

The information processing device 900 includes a CPU 901, a read only memory (ROM) 903, and a random access memory (RAM) 905. The information processing device 900 further includes a host bus 907, a bridge 909, an external bus 911, an interface 913, an input device 915, an output device 917, a storage device 919, a drive 921, a connection port 923, and a communication device 925. The information processing device 900 may include a processing circuit such as a digital signal processor (DSP) instead of or together with the CPU 901.

The CPU 901 functions as an arithmetic processing unit and a control device, and controls an overall operation or a part of an operation of the information processing device 900 according to various kinds of programs recorded in the ROM 903, the RAM 905, the storage device 919, or a removable recording medium 927. The ROM 903 stores a program, an operation parameter, and the like used by the CPU 901. The RAM 905 primarily stores a program used in execution of the CPU 901, a parameter that appropriately changes in the execution, and the like. The CPU 901, the ROM 903, and the RAM 905 are connected to one another via the host bus 907 configured with an internal bus such as a CPU bus. Further, the host bus 907 is connected to the external bus 911 such as a peripheral component interconnect/interface (PCI) through the bridge 909.

For example, the input device 915 is a device operated by the user such as a mouse, a keyboard, a touch panel, a button, a switch, and a lever. For example, the input device 915 may be a remote control device using an infrared ray or any other radio wave or may be an external connecting device 929 such as a mobile telephone that responds to an operation of the information processing device 900. The input device 915 includes an input/output (I/O) control circuit that generates an input signal based on information input by the user and outputs the input signal to the CPU 901. The user operates the input device 915 to input various kinds of data to the information processing device 900 or instruct the information processing device 900 to perform a processing operation.

The output device 917 is configured with a device capable of visually or auditorily notifying the user of acquired information. Examples of the output device 917 include a display device such as a liquid crystal display (LCD), a plasma display panel (PDP), an organic electro-luminescence (EL) display, an audio output device such as a speaker or headphones, and a printer device. The output device 917 outputs a video such as text or an image or a sound such as a voice or acoustics as a result obtained by processing of the information processing device 900.

The storage device 919 is a data storage device configured as an example of a storage unit of the information processing device 900. Examples of the storage device 919 include a magnetic storage device such as a hard disk drive (HDD), a semiconductor memory device, an optical storage device, and a magneto optical storage device. The storage device 919 stores a program executed by the CPU 901, various kinds of data, various kinds of data acquired from the outside, and the like.

The drive 921 is a reader/writer for the removable recording medium 927 such as a magnetic disk, an optical disc, a magneto optical disc, or a semiconductor memory, and is equipped in or externally mounted to the information processing device 900. The drive 921 reads information recorded in the mounted removable recording medium 927, and outputs the read information to the RAM 905. Further, the drive 921 writes a record in the mounted removable recording medium 927.

The connection port 923 is a port through which a device is connected directly to the information processing device 900. Examples of the connection port 923 include a universal serial bus (USB) port, an IEEE1394 port, and a small computer system interface (SCSI) port. Further, the connection port 923 may be an RS-232C port, an optical audio terminal, or a high-definition multimedia interface (HDMI) port. As the external connecting device 929 is connected to the connection port 923, various kinds of data can be exchanged between the information processing device 900 and the external connecting device 929.

For example, the communication device 925 is a communication interface configured with a communication device that provides a connection to a communication network 931. For example, the communication device 925 may be a communication card for a wired or wireless local area network (LAN), Bluetooth (a registered trademark), or a wireless USB (WUSB). Further, the communication device 925 may be a router for optical communication, a router for an asymmetric digital subscriber line (ADSL), or a modem for various kinds of communication. For example, the communication device 925 performs transmission and reception of a signal or the like with the Internet or another communication device using a predetermined protocol such as TCP/IP. Further, the communication network 931 connected to the communication device 925 is a network connected in a wired or wireless manner, and examples of the communication network 931 include the Internet, a home LAN, an infrared-ray (IR) communication network, a radio wave communication, and a satellite communication network.

The exemplary hardware configuration of the information processing device 900 has been described above. Each of the components may be configured using a generic member or may be configured with hardware specific to a function of each component. This configuration may be appropriately changed according to a technical level when implemented.

### 4. Supplement

An embodiment of the present disclosure may include the information processing device and the system described above, an information processing method executed by the information processing device or system, a program for causing the information processing device to operate, and a non-temporary recording medium including a program recorded therein.

Although the above embodiments have been described in connection with the example of the collaborative filtering using a valuation matrix as an input, an example of the present disclosure is not limited to this example. A technology according to the present disclosure can be applied in any case as long as an output matrix including a prediction value of an unknown element is calculated through a matrix calculation using an input matrix including the unknown element. Thus, for example, an element of an input matrix may be a distance between pieces of data in a feature amount space or may be any other statistic amount. Depending on information to be dealt with, processing need not necessarily be performed by a server, and for example, processing may be performed by a terminal device such as a personal computer (PC) used by the user. Alternatively, processing may be dispersed between and performed by the terminal device and the server. In this case, an input unit and an output unit may be implemented by an I/O device such as a keyboard or a display equipped in the terminal device.

The preferred embodiments of the present disclosure have been described above with reference to the accompanying drawings, whilst the technical scope of the present disclosure is not limited to the above examples, of course. A person skilled in the art may find various alternations and modifications within the scope of the appended claims, and it should be understood that they will naturally come under the technical scope of the present disclosure.

Additionally, the present technology may also be configured as below:

(1) An information processing device, including:

a predictive calculating unit that alternately recalculates a pair of matrices derived from an input matrix including an unknown element with reference to the input matrix, and generates a pair of feature matrices used to calculate an output matrix including a prediction value of the unknown element,

wherein the input matrix includes a first input matrix and a second input matrix configured such that some elements of the first input matrix are updated,

wherein the output matrix includes a first output matrix calculated corresponding to the first input matrix and a second output matrix calculated corresponding to the second input matrix, and

wherein the predictive calculating unit causes a number of the recalculations when the pair of feature matrices are generated from the second input matrix to be smaller than a number of the recalculations when the pair of feature matrices are generated from the first input matrix, by using the pair of feature matrices generated from the first input matrix instead of the pair of matrices derived from the second input matrix.

(2) The information processing device according to (1),

wherein the predictive calculating unit limits a target of the recalculation when the pair of feature matrices are generated from the second input matrix to some rows including a row corresponding to the updated element.

(3) The information processing device according to (2),

wherein the some rows include the row corresponding to the updated element and at least one other row.

(4) The information processing device according to (3),

wherein the some rows include the row corresponding to the updated element and at least one row corresponding to an element which is high in correlation with the updated element.

(5) The information processing device according to any one of (1) to (4), further including:

a recalculation determining unit that alternately recalculates a pair of matrices derived from the second input matrix with reference to the second input matrix when a predetermined condition is satisfied, and decides that the pair of feature matrices are to be regenerated.

(6) The information processing device according to (5), further including:

an error estimating unit that estimates an error between the second input matrix and the second output matrix calculated based on the pair of feature matrices,

wherein the recalculation determining unit decides that the pair of feature matrices are to be regenerated when the error exceeds a predetermined range.

(7) The information processing device according to (6),

wherein the error estimating unit compares a known element of the second input matrix and a prediction value of the corresponding element in the second output matrix, and calculates the error.

(8) The information processing device according to any one of (5) to (7),

wherein the recalculation determining unit decides that the pair of feature matrices are to be regenerated when a calculation of the pair of feature matrices using the pair of feature matrices generated from the first input matrix instead of the pair of matrices derived from the second input matrix has been performed a predetermined number of times.

(9) The information processing device according to any one of (5) to (8),

wherein the recalculation determining unit decides that the pair of feature matrices are to be regenerated every predetermined time period.

(10) The information processing device according to any one of (5) to (9),

wherein the recalculation determining unit decides that the pair of feature matrices are to be regenerated when a predetermined number of rows or columns are added to the input matrix.

(11) The information processing device according to any one of (1) to (10), further including:

an input unit that temporally disperses and sequentially receives input of update data for updating an element of the input matrix.

(12) The information processing device according to (11), further including:

an input matrix generating unit that generates the input matrix using an evaluation value of an item by a user as an element, and updates an element of the input matrix when the update data is input;

an output matrix calculating unit that calculates the output matrix based on the pair of feature matrices; and

a recommended item output unit that outputs recommendation information of the item to the user based on the prediction value included in the output matrix in response to input of the update data.

(13) An information processing method, including:

generating a pair of feature matrices by acquiring a first input matrix including an unknown element and alternately recalculating a pair of matrices derived from the first input matrix with reference to the first input matrix, and calculating a first output matrix including a prediction value of the unknown element based on the pair of feature matrices; and

generating a new pair of feature matrices by acquiring a second input matrix configured such that some elements of the first input matrix are updated and alternately recalculating the pair of feature matrices generated from the first input matrix with reference to the second input matrix, and calculating a second output matrix including a prediction value of the unknown element based on the pair of feature matrices,

wherein a number of the recalculations when the second output matrix is calculated is smaller than a number of the recalculations when the first output matrix is calculated.

(14) A program that causes a computer to implement a function of alternately recalculating a pair of matrices derived from an input matrix including an unknown element with reference to the input matrix, and generating a pair of feature matrices used to calculate an output matrix including a prediction value of the unknown element,

wherein the input matrix includes a first input matrix and a second input matrix configured such that some elements of the first input matrix are updated,

wherein the output matrix includes a first output matrix calculated corresponding to the first input matrix and a second output matrix calculated corresponding to the second input matrix, and

wherein the function causes a number of the recalculations when the pair of feature matrices are generated from the second input matrix to be smaller than a number of the recalculations when the pair of feature matrices are generated from the first input matrix, by using the pair of feature matrices generated from the first input matrix instead of the pair of matrices derived from the second input matrix.

What is claimed is:

1. An information processing device, comprising:
a predictive calculating unit that alternately recalculates a pair of matrices derived from an input matrix including an unknown element with reference to the input matrix, and generates a pair of feature matrices used to calculate an output matrix including a prediction value of the unknown element,
wherein the input matrix includes a first input matrix and a second input matrix configured such that some elements of the first input matrix are updated,
wherein the output matrix includes a first output matrix calculated corresponding to the first input matrix and a second output matrix calculated corresponding to the second input matrix, and
wherein the predictive calculating unit causes a number of the recalculations when the pair of feature matrices are generated from the second input matrix to be smaller than a number of the recalculations when the pair of feature matrices are generated from the first input matrix, by using the pair of feature matrices generated from the first input matrix instead of the pair of matrices derived from the second input matrix.

2. The information processing device according to claim 1,
wherein the predictive calculating unit limits a target of the recalculation when the pair of feature matrices are generated from the second input matrix to some rows including a row corresponding to the updated element.

3. The information processing device according to claim 2,
wherein the some rows include the row corresponding to the updated element and at least one other row.

4. The information processing device according to claim 3,
wherein the some rows include the row corresponding to the updated element and at least one row corresponding to an element which is high in correlation with the updated element.

5. The information processing device according to claim 1, further comprising:
a recalculation determining unit that alternately recalculates a pair of matrices derived from the second input matrix with reference to the second input matrix when a predetermined condition is satisfied, and decides that the pair of feature matrices are to be regenerated.

6. The information processing device according to claim 5, further comprising:
an error estimating unit that estimates an error between the second input matrix and the second output matrix calculated based on the pair of feature matrices,
wherein the recalculation determining unit decides that the pair of feature matrices are to be regenerated when the error exceeds a predetermined range.

7. The information processing device according to claim 6,
wherein the error estimating unit compares a known element of the second input matrix and a prediction value of the corresponding element in the second output matrix, and calculates the error.

8. The information processing device according to claim 5,
wherein the recalculation determining unit decides that the pair of feature matrices are to be regenerated when a calculation of the pair of feature matrices using the pair of feature matrices generated from the first input matrix instead of the pair of matrices derived from the second input matrix has been performed a predetermined number of times.

9. The information processing device according to claim 5,
wherein the recalculation determining unit decides that the pair of feature matrices are to be regenerated every predetermined time period.

10. The information processing device according to claim 5,
wherein the recalculation determining unit decides that the pair of feature matrices are to be regenerated when a predetermined number of rows or columns are added to the input matrix.

11. The information processing device according to claim 1, further comprising:
an input unit that temporally disperses and sequentially receives input of update data for updating an element of the input matrix.

12. The information processing device according to claim 11, further comprising:
an input matrix generating unit that generates the input matrix using an evaluation value of an item by a user as an element, and updates an element of the input matrix when the update data is input;
an output matrix calculating unit that calculates the output matrix based on the pair of feature matrices; and
a recommended item output unit that outputs recommendation information of the item to the user based on the prediction value included in the output matrix in response to input of the update data.

13. An information processing method, comprising:
generating a pair of feature matrices by acquiring a first input matrix including an unknown element and alternately recalculating a pair of matrices derived from the first input matrix with reference to the first input matrix, and calculating a first output matrix including a prediction value of the unknown element based on the pair of feature matrices; and
generating a new pair of feature matrices by acquiring a second input matrix configured such that some elements of the first input matrix are updated and alternately recalculating the pair of feature matrices generated from the first input matrix with reference to the second input matrix, and calculating a second output matrix including a prediction value of the unknown element based on the pair of feature matrices,
wherein a number of the recalculations when the second output matrix is calculated is smaller than a number of the recalculations when the first output matrix is calculated.

14. A program that causes a computer to implement a function of alternately recalculating a pair of matrices derived from an input matrix including an unknown element with reference to the input matrix, and generating a pair of feature matrices used to calculate an output matrix including a prediction value of the unknown element,
wherein the input matrix includes a first input matrix and a second input matrix configured such that some elements of the first input matrix are updated,
wherein the output matrix includes a first output matrix calculated corresponding to the first input matrix and a second output matrix calculated corresponding to the second input matrix, and
wherein the function causes a number of the recalculations when the pair of feature matrices are generated from the second input matrix to be smaller than a number of the recalculations when the pair of feature matrices are generated from the first input matrix, by using the pair of feature matrices generated from the first input matrix instead of the pair of matrices derived from the second input matrix.
